(19) United States
(12) Patent Application Publication
(10) Pub. No.: US 2004/0054808 A1
(43) Pub. Date: Mar. 18, 2004

(54) Method and apparatus for bi-directional translation of naming service data

(75) Inventor: Ulf P. Ekberg, Soguel, CA (US)

Correspondence Address: John F. Nethery, SONNENSCHEIN NATH & ROSENTHAL, Wacker Drive Station, Sears Tower, P.O. Box # 061080, Chicago, IL, 60606-1080, US

(73) Assignee: SUN MICROSYSTEMS, INC.

(21) Appl. No.: 10/243,804

(22) Filed: Sep. 13, 2002

(51) Int. Cl. G06F 15/16

(52) U.S. Cl. 709/245

(57) ABSTRACT

Methods and systems consistent with the present invention bi-directionally translate between a legacy naming service protocol and a current naming service protocol. As a result, companies may initiate support under the current naming service without losing operability of legacy clients. The legacy clients may then be gradually migrated to the current naming service.

A computer program listing appendix on compact disc is included in this application. The computer program listing comprises a mapping file named “mapping.txt” that is 30,751 bytes in size and that was saved on the compact disc Aug. 26, 2002. The computer program listing is incorporated herein in its entirety.

### FIELD OF THE INVENTION

This invention relates to providing interoperability between data processing systems that support different data storage paradigms. In particular, this invention relates to providing interoperability between clients and servers supporting distinct naming services.

### BACKGROUND OF THE INVENTION

Naming services provide a mechanism for consolidating and managing user and system information and are particularly suited for large organizations with many thousands of users. Thus, in the past, naming services such as NIS+ (Network Information Services, Plus) and LDAP (Lightweight Directory Access Protocol) evolved for implementing central repositories of user, group, and access control information. LDAP has been adopted by and incorporated into products from Netscape and Microsoft, and a detailed description can be found, for example, in RFC-1777, available from many sources, including rfc.sunsite.dk/rfc/rfc1777.html. NIS+ has been incorporated into operating system products available from Sun Microsystems and more information can be found, for example, in All About Administering NIS+, published by Prentice Hall PTR, July, 1994.

Recently, LDAP has emerged as the industry standard for providing a naming service. The general acceptance of LDAP places a tremendous burden on system administrators of NIS+ client data processing systems (“clients”) as an organization transitions to LDAP support. In particular, it may often be the case that thousands of clients need to be transitioned away from NIS+ to LDAP. In addition, the information in the existing NIS+ database needs to be integrated into the central LDAP repository.

System administrators cannot shut down every client at once to transition the clients to a new naming service without creating an unacceptable performance, time, and revenue impact. However, while a client does not support the new naming service, the client continues to expect to interact with NIS+ services. Thus, even as the organization in general tries to move to LDAP, the clients are continuing to make access requests and store new data in the NIS+ database.

Therefore, a need has long existed for methods and systems to provide interoperability between different data storage paradigms that overcomes the problems noted above and others previously experienced.

### SUMMARY OF THE INVENTION

Methods and systems consistent with the present invention interface legacy naming service clients to a current naming service server. Thus, clients may be migrated over to the current naming service gradually. As a result, the performance, time, and revenue impacts of transitioning clients to the new naming service are mitigated.

According to one aspect of the present invention, such methods and systems, as embodied and broadly described herein, include bi-directionally translating between a legacy naming service protocol and a current naming service protocol. As a result, the methods and systems allow an organization to initiate support under the current naming service without losing operability of legacy clients.

In accordance with methods consistent with the present invention, a method is provided in a data processing system. The method includes receiving, at a first naming service server, a first naming service request from a client, translating the first naming service request into a second naming service request, and receiving, at the first naming service server, a second naming service response to the second naming service request. The method further includes translating the second naming service response to a first naming service response, and sending the first naming service response to the client.

In accordance with system consistent with the present invention, a data processing system is provided. The data processing system includes a memory that holds a compatibility program. The compatibility program receives from a client a first access request compatible with a first naming service, translates the first access request into a second access request compatible with a second naming service, and receives a first access response compatible with the second naming service. The compatibility program further translates the first access response to a second access response compatible with the first naming service, and sends the second access response to the client. The data processing system also includes a processor that runs the compatibility program.

A computer-readable medium is also provided. The computer readable-medium contains instructions that cause a data processing system to perform a method. The method includes receiving from a client a first access request compatible with a first naming service, translating the first access request into a second access request compatible with a second naming service, and receiving a first access response compatible with the second naming service. The instructions also cause the data processing system to translate the first access response to a second access response compatible with the first naming service, and send the second access response to the client.

Other apparatus, methods, features and advantages of the present invention will be or will become apparent to one with skill in the art upon examination of the following figures and detailed description. It is intended that all such additional systems, methods, features and advantages be included within this description, be within the scope of the present invention, and be protected by the accompanying drawings.

### BRIEF DESCRIPTION OF THE DRAWINGS

FIG. 1 depicts a block diagram of a data processing system suitable for practicing methods and implementing systems consistent with the present invention.

FIG. 2 depicts a flow diagram showing processing performed by the compatibility program running in the data processing system shown in FIG. 1 in order to provide interoperability between naming services.

FIG. 3 depicts a flow diagram showing processing performed by the compatibility program running in the data processing system shown in FIG. 1 in order to translate an NIS+ request into an LDAP request.

FIG. 4 depicts a flow diagram showing processing performed by the compatibility program running in the data processing system shown in FIG. 1 in order to translate an LDAP response into an NIS+ response.

### DETAILED DESCRIPTION OF THE INVENTION

Reference will now be made in detail to an implementation in accordance with methods, systems, and products consistent with the present invention as illustrated in the accompanying drawings. The same reference numbers may be used throughout the drawings and the following description to refer to the same or like parts.

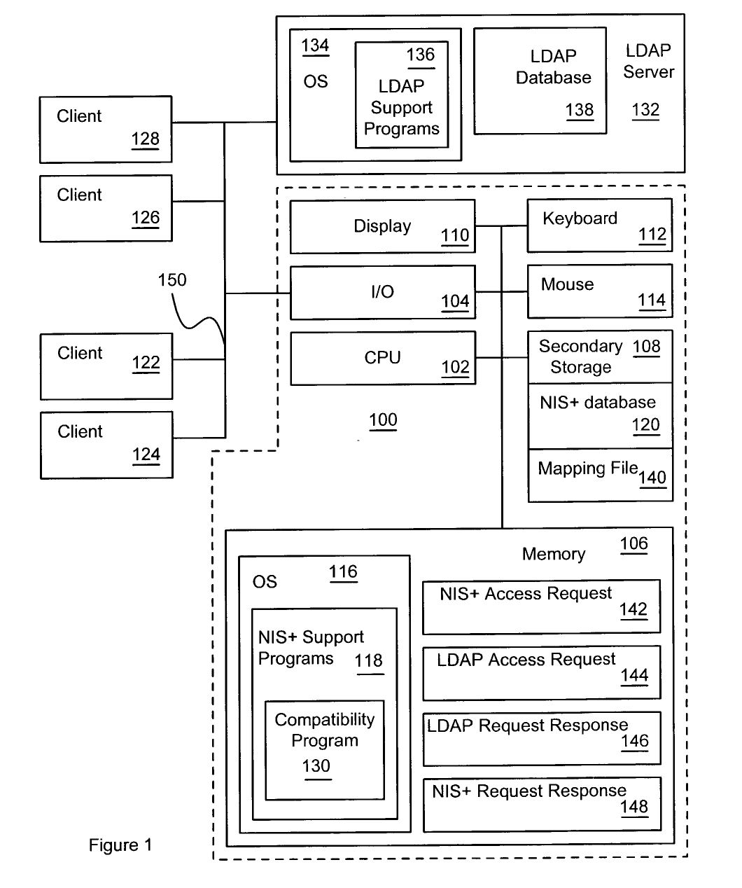

FIG. 1 depicts a block diagram of a data processing system 100 suitable for practicing methods and implementing systems consistent with the present invention. As will be explained in more detail below, the data processing system 100 is typically a Network Information System Plus (NIS+ ) server responsible for handling client requests and updates from and to a NIS+ database. The data processing system is therefore referred to below as the NIS+ server 100. The NIS+ server 100 comprises a central processing unit (CPU) 102, an input output I/O unit 104, a memory 106, a secondary storage device 108, and a video display 110. The NIS+ server 100 may further include input devices such as a keyboard 112, a mouse 114 or a speech processor (not illustrated).

The memory 106 contains an operating system 116 (e.g., Solaris 9 from Sun Microsystems). The operating system 116 includes NIS+ support programs 118 that handle NIS+ information requests and updates to the NIS+ database 120 stored in the secondary storage 108. The requests and updates arrive from the NIS+ client data processing systems (several of which are shown in FIG. 1 with labels 122, 124, 126, and 128). The requests generally are queries for information from the NIS+ database, while the updates generally instruct the NIS+ database to store new information or update existing information. The requests and updates are both examples of access requests on the NIS+ database.

In particular, however, the operating system 116 includes a compatibility program 130 that allows the data processing system 100 to inter-operate between NIS+ and Lightweight Directory Access Protocol (LDAP) databases. In one embodiment, the compatibility program 130 is a functionality extended (as explained below) version of the rpc.nisd daemon included in the NIS+ support programs 118. Note that the LDAP database is generally stored on an LDAP server 132 that runs an operating system 134 that includes LDAP support programs 136 for handling client requests and updates to the LDAP database 138.

The compatibility program 130 reads a mapping file 140 (typically stored in the secondary storage 108) as an aid in determining how to map information requests and updates bi-directionally between NIS+ and LDAP. As will be explained in more detail below, the NIS+ server 100 receives, for example, a NIS+ access request 142 (e.g., wrapped in an NIS+ protocol message), then invokes the compatibility program 130 to translate the NIS+ access request 142 into an LDAP access request 144 (e.g., wrapped in an LDAP protocol message) that can be understood by the LDAP server 132. Similarly, when the NIS+ server 100 receives an LDAP access request response 146, the compatibility program 130 forms a corresponding NIS+ access request response 148.

Because the NIS+ client is able to interface with the LDAP server, the NIS+ client need not be immediately migrated over to the LDAP naming service. In other words, legacy NIS+ clients can remain NIS+ clients and be gradually switched over to LDAP clients. As a result, the adverse performance, time, and revenue impacts that would arise from simultaneously shutting down each client and transitioning each client to the new naming service are avoided. Rather, each client in the network remains fully operable while the transition to LDAP occurs.

Note that the data NIS+ server 100 and the LDAP server 132 may communicate bi-directionally via message passing over the network 150 (e.g., an Ethernet TCP/IP based network), remote procedure calls, and the like. In other embodiments, the NIS+ server 100 and the LDAP server 132 may be running on a single data processing system, or distributed across additional data processing systems across the network 150.

Although aspects of the present invention are depicted as being stored in memory 106, one skilled in the art will appreciate that all or part of systems and methods consistent with the present invention may be stored on or read from other computer-readable media, for example, secondary storage devices such as hard disks, floppy disks, and CD-ROMs; a signal received from a network such as the Internet; or other forms of ROM or RAM either currently known or later developed. Further, although specific components of data processing system 100 are described, one skilled in the art will appreciate that a data processing system suitable for use with methods, systems, and articles of manufacture consistent with the present invention may contain additional or different components.

Before proceeding below, it is noted that detailed explanations and definitions for the function calls, structures, and the like, that are recited below may be found in the manual pages (i.e., man pages) on the data processing systems that have been configured to support the service in question. Thus, the man pages stored on NIS+ clients running the UNIX operating system, or a variant of the UNIX operating system, contain detailed information, as examples, for the functions “nis_list( )”, “gethostbyname( )”, and for the structure “hostent”.

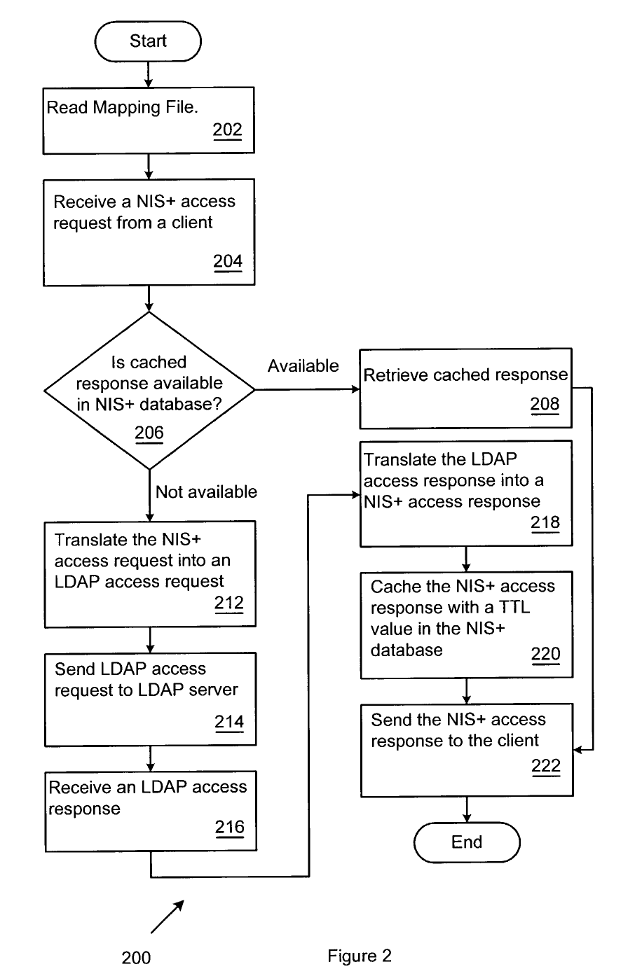

Turning next to FIG. 2, that figure shows a flow diagram 200 of the steps performed by the compatibility program 130 in providing interoperability between the NIS+ naming service and the LDAP naming service. Note that in general, the compatibility program 130 executes in the background as a daemon process waiting to perform the steps described below. The compatibility program (e.g., at startup, or periodically after beginning to execute) reads the mapping file 140 (Step 202). As will be explained in detail below, the mapping file 140 includes translation rules that specify how to bi-directionally map request types between NIS+ format and LDAP format.

Once the compatibility program 130 has read the mapping file, the compatibility program waits to receive an NIS+ access request from an NIS+ client (Step 204). Because a suitable response to the access request may have already been recently provided, the compatibility program 130 checks a cache to determine if a suitable response is available (Step 206). To that end, for example, the compatibility program 130 may use the NIS+ database 120 to cache prior responses.

The compatibility program 130 may also determine whether a prior response in the cache is stale by checking a time-to-live (TTL) parameter stored with the prior response in the cache. For example, the TTL parameter may specify a time in seconds (e.g., 3600, or one hour) during which the cached response is considered good information.

If the cached response is available and has not exceeded its TTL, then the compatibility program 130 retrieves the cached response (Step 208). The cached response is sent to the client as the NIS+ access response to the NIS+ access request (Step 222).

On the other hand, when an access response cannot be provided by the cache, the compatibility program 130 translates the NIS+ access request into an LDAP access request (Step 212). As will be explained in more detail below, the compatibility program 130 determines a request type associated with the access request, and applies the corresponding translation rule specified by the mapping file 140. The result is an LDAP compatible access request that is sent to the LDAP server 132 for processing (Step 214).

The LDAP server 132 processes the request and returns an LDAP access response to the NIS+ server 100. The NIS+ server 100 receives the LDAP access response (Step 216). As will be explained in more detail below, in accordance with the response type applicable to the LDAP access response, the NIS+ server 100 translates the LDAP access response into an NIS+ compatible access response (Step 218). The NIS+ compatible access response may optionally be cached, for example in the NIS+ database 120, with a TTL value specified by the mapping file 140 (Step 220). The compatibility program 130 subsequently sends the NIS+ access response to the client (Step 222).

As a result, the client continues to issue and receive NIS+ formatted access requests and responses. However, the compatibility program 130 passes the access requests to the LDAP server 132 for processing and application to the LDAP database 138. Thus, existing NIS+ clients, in fact, use the LDAP database 138 for their transactions, although it appears from the client perspective that the client is interacting with a NIS+ server.

As noted above, the NIS+ database 120 may instead act as a local cache for the NIS+ access requests. Note that the information in the NIS+ database is imported once into the LDAP database 138 before the compatibility program 130 begins execution. Subsequent naming service interaction on the part of the client actually happens with respect to the LDAP database 138, although the client is generally unaware of that fact.

A specific example of a bidirectional translation between NIS+ and LDAP is given below with respect to a naming service call to resolve a host name. Assume, for example, that a web browser running on the client 122 (located in a domain “somewhere”) is asked to display a web page at the URL “http://coyote.acme.com/roadrunner-traps”. The portion of the URL between “//” and “/” is a host name that needs to be resolved to an IP address, typically using a system library call “gethostbyname” and an appropriate structure variable to hold the result: struct hostent *hp=gethostbyname(“coyote.acme.com”).

The example makes references to Tables 1-9. Table 1 sets forth how an NIS+ database stores hostname information in a table and Table 2 shows the corresponding information stored in an LDAP service. Table 9 shows the updated table in the NIS+ database after the hostname is resolved. Tables 3-8 set forth one possible implementation of the translation process in the mapping file 140. Table 3 shows a label definition that provides a more convenient reference for a particular table throughout the mapping file 140. Table 4 shows the definition of a time to live (TTL) entry in the mapping file. Table 5 shows a definition of a location information entry that specifies where in LDAP the hostname information resides. Table 6 provides an explanation of the component parts of the location information entry. Table 7 provides a translation rule for mapping an NIS+ request to an LDAP request, while Table 8 provides a translation rule for mapping an LDAP response to an NIS+ response.

Following the detailed example is a more general discussion of the format of the mapping file 140. The discussion makes use of Tables 10-19. Table 10 explains the syntax of labels in the mapping file 140 and Table 11 explains the syntax of TTL entries. Table 12 shows the syntax of a location information entry, while Table 13 sets forth the syntax for deriving an NIS+ column from an LDAP attribute. Table 14 sets forth several pseudo-columns used to store non-column object data. Table 15 provides the syntax for deriving an LDAP attribute from a NIS+ column and Table 16 provides the syntax for a parameter set forth in both Tables 13 and 15.

Tables 17 and 18 recite supported wildcards and string manipulation functions, respectively. Table 19 summarizes the types of values that may be used in the mapping file 140. Finally, the computer program listing appendix provides an exemplary mapping file “mapping.txt” for supporting bidirectional communication between NIS+ clients and LDAP servers.

Returning to the example, the gethostbyname function determines that NIS+ is used to look up host names, and makes an NIS+ API call to retrieve the host name. Because a NIS+ database typically stores the host name information in a table called “hosts.org_dir”, a NIS+ lookup call may take the following form: nis_result *res=nis_list(“[name=coyote.acme.com]hosts.org_dir”, EXPAND_NAME, NULL, NULL). The lookup call includes an access request (the portion between quotation marks) that searches for an entry in the hosts.org_dir table that has a name field set to coyote.acme.com.

The nis_list NIS+ API function packages the lookup call into an NIS+ protocol packet, and sends the protocol packet over the network to the compatibility program 130 daemon (i.e., the compatibility program 130) running on the NIS+ server 100. The compatibility program 130 unpacks the NIS+ protocol packet, performs verifications (e.g., checks access control rights), then proceeds to search for the requested information cached in the NIS+ database 120.

Specifically, the compatibility program 130 looks for the string “coyote.acme.com” in the “name” column of the “host.org_dir.some.where” table, and may, for example, find the first entry shown in Table 1:

TABLE 1

| cname | name | addr |
|---|---|---|
| acme.com | coyote.acme.com | 1.2.3.4 |
| design.com | reports.design.com | 100.100.10.100 |
| servers.com | web1.servers.com | 33.100.99.133 |

Each entry includes an associated TTL value stored in a separate data structure. The acme.com entry, for example, may have a TTL value of 3600 seconds attached to it. The compatibility program 130 verifies that the current time is no later than the expiration time (i.e., the entry is not stale). If the entry is not stale, then the compatibility program 130 reads the cached entry and returns it to the client 122 in the format for an NIS+ access response determined by the nis_list API function.

If there is no appropriate cached entry, or if the TTL value has expired, then the compatibility program 130 converts the NIS+ access request to an LDAP access request and sends the LDAP access request to the LDAP server 132 for processing.

The LDAP database stores host name information in a different format, shown in Table 2.

TABLE 2
dn=acme.com+ipHostNumber=1.2.3.4,ou=Hosts,dc=some,dc=where
objectClass=ipHost
objectClass=device
objectClass=top
cn=acme.com
cn=coyote.acme.com
ipHostNumber=1.2.3.4

The first line in the LDAP entry is a distinguished name (dn) which is a complete and unique label for the entry. Lines two, three, and four list the object classes to which the entry belongs and determine required and valid attributes for the entry, as well as the legal syntax for those attributes. The entry shown in Table 2 has two common name (cn) attribute values, one of which is the official (canonical) value (i.e., that value that appears in the dn line). The entry also has a single ipHostNumber attribute value.

The mapping file 140 includes definitions and translation rules for converting between NIS+ access requests and LDAP access requests. In one implementation, the mapping file 140 defines up to five attribute values for each NIS+ object (such as an NIS+ table) that is mapped to or from LDAP. The attribute values are set forth below, with examples given in Tables 3, 4, 5, 7, and 8.

Note first that the mapping file 140 may include more than translation rules (e.g., definitions, TTL specifications, and location information). For example, the definition shown in Table 3 defines the label “hosts” to be used for the “hosts.org_dir” table in the remainder of the mapping file 140.

TABLE 3

nisplusLDAPdatabaseIdMapping
hosts:[addr=“[1-9*].[1-9]*.[1-9]*.[1-9]*”]hosts.org_dir

The definition shown in Table 3 specifies that the “hosts” label applies to entries in the “hosts.org_dir” table where the “addr” column value matches the wildcard string “[1-9]*.[1-9]*.[1-9]*.[1-9]*”. In other words, addresses that have four parts, separated by dots, and where each part starts with a digit. The four digit wildcard string is provided because LDAP stores both Internet Protocol Version 4 and Version 6 (IPv4 and IPv6) address in the same type of entry, while NIS+ separates IPv4 and IPv6 addresses to the “hosts.org_dir” and “ipnodes.org_dir” tables, respectively. Hence, the selection portion, [addr=“[1-9]*.[1-9]*.[1-9]*.[1-9]*”], of the nisplusLDAPdatabaseIdMapping value for “hosts” specifies a format that matches IPv4, but not IPv6 addresses.

The mapping file 140 also specifies a TTL value for entries in certain tables. An exemplary entry is shown in Table 4:

TABLE 4

| | |
|---|---|
| nisplusLDAPentryTtl | hosts:1800:3600:3600 |

The TTL entry shown in Table 4 specifies that entries in the table identified by the “hosts” label (i.e., the “hosts.org_dir” table) get a time-to-live (TTL) of between half an hour and one hour (1800 to 3600 seconds) when the compatibility program 130 first starts up, and a TTL of one hour when entries in the form of access request responses are received from LDAP. The expiration time is the time when the entry is created or refreshed, plus the TTL.

The mapping file 140 includes a location information entry that informs the compatibility program 130 where, in LDAP, the host information is stored. Table 5 shows an exemplary entry.

TABLE 5

| | |
|---|---|
| nisplusLDAPobjectDN | hosts:ou=Hosts,?one?objectClass=ipHost:\ |
| | ou=Hosts,?one?objectClass=ipHost,\ |
| | objectClass=device,objectClass=top |

The specification shown in Table 5 has three parts, separated by colons (the ‘\’ is a line continuation character). The first part is the label, “hosts”, and the second is the location from which to read LDAP data. There are three sub-parts, separated by question marks, explained in Table 6.

TABLE 6

| | |
|---|---|
| ou=Hosts, | The LDAP container (i.e., a collection of related |
| | entries) for host information. Since this sub-part |
| | ends with a comma, the base DN (“dc=some,dc= |
| | where”, based on the client 122 residing in the |
| | “some.where” domain) will be appended |
| | automatically. |
| one | The scope, “one” in this case meaning that LDAP |
| | should search for entries that are immediate children |
| | of the container. |
| objectClass=ipHost | Specifies that LDAP should search for entries that |
| | have the objectClass value “ipHost”. Such entries |
| | may have other objectClass values as well, but |
| | selecting on the “ipHost” object class is |
| | specified here. |

Note that the third part is the location to which LDAP data is written. The format is the same as that of the read location; the write location specification generally includes every objectClass value (for entry creation).

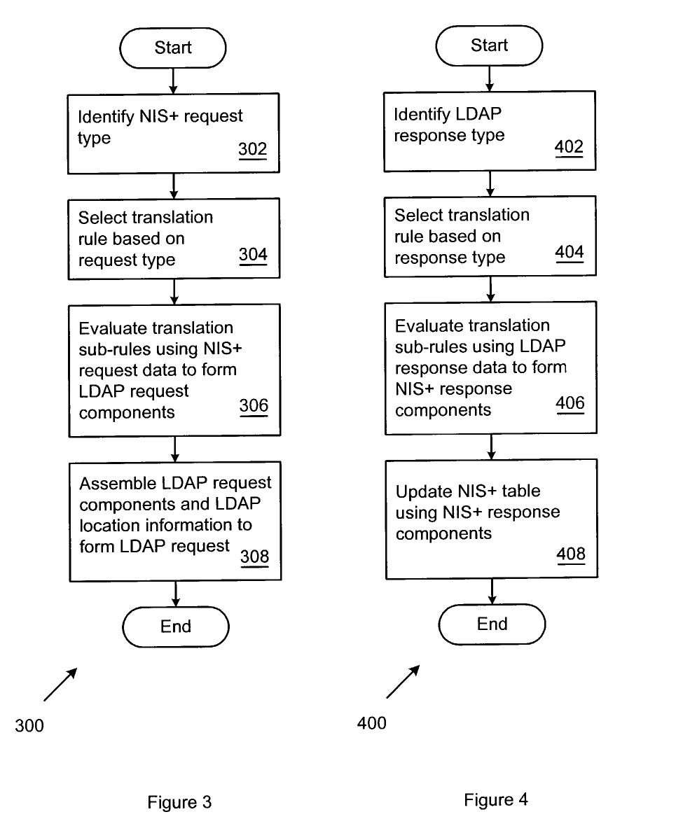

The discussion below sets forth an example of the translation process in conjunction with the flow diagram provided in FIG. 3. The compatibility program 130 first determines an NIS+ request type associated with the NIS+ request (Step 302). The NIS+ request type characterizes the type of data that the NIS+ request is requesting or updating. The mapping file 140 provides a translation rule that the compatibility program 130 uses to derive an LDAP access request from entries present in the NIS+ access request. For example, an exemplary translation rule is shown in Table 7 for an NIS+ access request that has a request type of “hosts” for hostname information:

TABLE 7
nisplusLDAPattributeFromColumn \

| | |
|---|---|
| hosts: | dn=(“cn=%s+ipHostNumber=%s,”, cname, addr), \ |
| | cn=cname, \ |
| | cn=name, \ |
| | ipHostNumber=addr, \ |

description=comment

Thus, the compatibility program selects the translation rule (identified by the “hosts” label) shown in Table 7 (Step 304). The translation rule in Table 7 is used when writing NIS+ data to LDAP, and also to formulate an LDAP access request from a NIS+ access request. Recall from above that In this case, the access request specified that the NIS+ “name” column should have the value “coyote.acme.com”, but did not specify a cname, comment, or addr. The compatibility program 130 evaluates the translation sub-rules one by one to form LDAP request components (Step 306).

The translation sub-rules are the individual rules that together provide translation of data from one naming service format to a different naming service format. The translation sub-rules are generally listed line-by-line inside the overall translation rule. The compatibility program 130 then assembles the LDAP request components (and LDAP location information) to form an LDAP access request from the result (Step 308).

The sub-rule: dn=(“cn=% s+ipHostNumber=% s,”, cname, addr) yields no result, since the compatibility program 130 does not know either the “cname” or “addr” value (they were not specified in the NIS+ access request). The sub-rule: cn=cname also yields nothing, for the same reason, while applying the sub-rule cn=name to the NIS+ request data yields the LDAP request component “cn=coyote.acme.com” (because the NIS+ access request specified that name=coyote.acme.com). The last two sub-rules also yield nothing.

The compatibility program then composes the LDAP access request from the result of the sub-rule evaluation (i.e., the LDAP request components) and from the appropriate LDAP location information. In this case, the third sub-part of the read location that specifies where in LDAP to find the requested information provides the relevant LDAP location information. The LDAP request is then: “(&(cn=coyote.acme.com)(objectClass=ipHost))”. The access request specifies that the compatibility program 130 is searching for an LDAP entry that has a “cn” value of “cn=coyote.acme.com”, and also an “objectClass” value of “ipHost”. The compatibility program 130 sends the LDAP access request to the LDAP server 132. The LDAP server 132 performs an LDAP search using the location information and the access request, and finds a match (the LDAP entry shown above in Table 2).

The LDAP server 132 returns the LDAP entry in Table 2 to the NIS+ server 100 as an LDAP access request response. With reference to the flow diagram in FIG. 4, the compatibility program 130 then translates the LDAP access request response into a NIS+ access response. More specifically, the compatibility program 130 translates the information returned in the LDAP access request response into a form compatible with the NIS+ naming service, according to a translation rule specified in the mapping file 140.

First, the compatibility program 130 identifies the LDAP response type (Step 402). In this case, the compatibility program determines that the LDAP response type is a hostname response with information destined for an NIS+ “hosts” table. A suitable translation rule (shown below in Table 8 and identified by the “hosts” label) is selected (Step 404):

TABLE 8
nisplusLDAPcolumnFromAttribute \

| | |
|---|---|
| hosts: | cname=cn, \ |
| | (name)=(cn), \ |
| | addr=ipHostNumber, \ |
| | comment=description |

The compatibility program 130 evaluates the translation sub-rules using LDAP response data to form NIS+ response components (Step 406). In this case, the compatibility program 130 evaluates the translation sub-rule cname=cn which specifies that the “cname” column value is the first “cn” value (see Table 2). Hence, NIS+ response component for the “cname” column value is “acme.com”. Next, the compatibility program evaluates the translation sub-rule (name)=(cn). As discussed in more detail below, the parentheses around “cn” specify all “cn” values, while the parenthesis around “name” tells the compatibility program 130 to create one NIS+ entry for each “cn” value. Since there are two “cn” values, there will be two NIS+ entries. Each entry will be set to the NIS+ response component that results from evaluating the sub-rule (name)=(cn).

The sub-rule of the translation rule specifies that addr=ipHostNumber. In response, the compatibility program 130 determines that the “addr” column NIS+ response component is the “ipHostNumber” attribute value (i.e., “1.2.3.4”). In addition, the translation rule also specifies that comment=description. However, because there is no “description” attribute the “comment” column will be empty (i.e., there is no NIS+ response component that arises from evaluation of that sub-rule).

In sum, the compatibility program 130 creates (or refreshes, if they already existed in the NIS+ database 120 on the NIS+ server 100) the following two tables entries shown in Table 9 based on the NIS+ response components determined through application of the translation rule.

TABLE 9

| Column | cname | name | addr |
|---|---|---|---|
| Value | acme.com | acme.com | 1.2.3.4 |
| Value | acme.com | coyote.acme.com | 1.2.3.4 |

More specifically, the compatibility program 130 assembled the NIS+ response components to form an NIS+ response (Step 408). In the example above, two sets of NIS+ response components arose from the application of the translation rule. The first set of components is {acme.com, acme.com, 1.2.3.4} and the second set of components is {acme.com, coyote.acme.com, 1.2.3.4}. Together, the two sets of components are the NIS+ response that the compatibility program 130 uses to update the NIS+ hosts table. More generally, the NIS+ response generally takes the form of one or more data elements used to update a NIS+ table based on data in the LDAP response.

The two entries shown in Table 9 start with an expiration time that is 3600 seconds into the future (see Table 4).

Now that the information in the LDAP access response has been translated into a form suitable for NIS+, the compatibility program 130 may then form an NIS+ access response and return the requested information to the client 122. In this example, the compatibility program 130 returns the second NIS+ entry above, which matches the “name=coyote.acme.com” search criteria in the original NIS+ search request to the NIS+ client 122.

Finishing the example, the “nis_list” NIS+ API function returns the NIS+ search result to the “gethostbyname” function, which in turn returns a structure (containing the official name, aliases, and IP address of the remote host in the URL) to the application on the client 122. The browser uses the IP address to connect to the web site, and displays the web page.

More generally, the mapping file 140 supports attributes as noted below.

The nisplusLDAPbaseDomain attribute specifies the domain to append when NIS+ object names are not fully qualified. The default is the domain the compatibility program 130 is serving (or the first such domain, if there is more than one candidate).

The nisplusLDAPdatabaseldMapping attribute maps a database id to a NIS+ object. If the object name isn't fully qualified (i.e., it doesn't end in a dot), the nisplusLDAPbaseDomain is appended. The syntax of the attribute is shown below in Table 10.

TABLE 10

| databaseId “:” objectspec | |
|---|---|
| where: | |
| databaseId | = Label identifying a (subset of a) NIS+ |
| | object for mapping purposes. |
| objectspec | = objectname \| “[“ indexlist ”]” tablename |
| objectname | = The name of a NIS+ object (including tables) |
| tablename | = The name of a NIS+ table |
| indexlist | = colspec [“,” colspec] |

| | |
|---|---|
| colspec | = colname “=” colvalue |
| colname | = The name of a column in the table |

| | |
|---|---|
| colvalue | = colvaluestring \| \“ colvaluestring \” |

The “[indexlist]tablename” form is intended for those cases where it is desired to select a subset of a NIS+ table. The subset are those NIS+ entries that match the ‘indexlist’/ If there are multiple indexed specifications for a particular NIS+ table, they are tried in the order retrieved until one matches. Note that retrieval order usually is unspecified for multi-valued LDAP attributes. Hence, if using indexed specifications when nisplusLDAPdatabaseldMapping is retrieved from LDAP, the subset match should be unambiguous.

If the ‘colvaluestring’ contains white space or commas, it should either be surrounded by double quotes, or the special characters that are escaped. Wildcards are allowed in the ‘colvaluestring’. If the ‘objectname’/‘tablename’ isn't fully qualified (i.e., doesn't end in a dot character), the nisplusLDAPbaseDomain value is appended. If the ‘objectname’ is empty the value of nisplusLDAPbaseDomain is substituted.

For example, passwd:passwd.org_dir represents the “passwd.org_dir” table by the “passwd” database id, while credlocal:[auth_type=LOCAL]cred.org_dir associates the LOCAL entries in the “cred.org_dir” table with the “credlocal” database id. As another example, creduser:[auth_type=“D*”,auth_name=“unix.[0-9]*”]cred.org_dir uses the “creduser” database id for those entries in the “cred.org_dir” table that represent credentials (keys) for users (i.e., have a netname (auth_name) of the type “unix.<numeric-id>@domain”).

The nisplusLDAPentryTtl attribute establishes TTLs for NIS+ entries derived from LDAP. The syntax of the value is shown in Table 11:

TABLE 11

databaseId “:” initialTTLlo “:” initialTTLhi “:” runningTTL

In Table 11, initialTTLlo specifies the lower limit for the initial TTL (in seconds) for data read from disk when the compatibility program 130 starts. If initialTTLhi also is specified, the actual initialTTL will be randomly selected from the interval initialTTLlo to initialTTLhi (inclusive). Leaving the field empty yields the default value of, for example, 1800 seconds.

The entry initialTTLhi specifies the upper limit for the initial TTL. If left empty, defaults, for example, to 5400. The entry runningTTL specifies the TTL (in seconds) for data retrieved from LDAP while the compatibility program 130 is running. Leaving the field empty to gives rise a default value, for example, 3600 seconds. If there is no specification of TTLs for a particular databaseld, the default values are used.

The nisplusLDAPobjectDN attribute specifies the connection between a databaseld (and hence a NIS+ object, or part of a NIS+ table) and the LDAP directory. The syntax of the value is shown in Table 12.

TABLE 12
DatabaseId “:” objectDN *( “;” objectDN )
where:

| | |
|---|---|
| objectDN | = readObjectSpec [“:”[writeObjectSpec]] |

| | |
|---|---|
| readObjectSpec | = [baseAndScope [filterAttrValList]] |
| writeObjectSpec | = [baseAndScope [attrValList [“:” deleteDisp]]] |
| baseAndScope | = [baseDN] [“?” [scope]] |
| filterAttrValList | |

| | |
|---|---|
| | = [“?” [filter \| attrValList]]] |
| scope | = “base” \| “one” \| “sub” |
| attrValList | = attribute “=” value |

*(“,” attribute “=” value)

| | |
|---|---|
| deleteDisp | = “always” \| perDbId \| “never” |

| | |
|---|---|
| perDbId | = “dbid” “=” delDatabaseId |
| delDatabaseId | = database id per |
| | nisplusLDAPdatabaseIdMapping above. |

Note that the ‘baseDN’ defaults to the value of the ‘defaultSearchBase’ attribute. If the ‘baseDN’ ends in a comma, the ‘defaultSearchBase’ is appended. Also, ‘scope’ defaults to “one”, but is generally ignored in a ‘writeObjectSpec’. The ‘filter’ is an LDAP search filter. The ‘attrValList’ is a list of attribute/value pairs. If an attrValList is specified in a readObjectSpec it is converted to a search filter by ANDing together the attributes/values.

For example, the attribute/value list:

objectClass=posixAccount,objectClass=shadowAccount is converted to the access request (&(objectClass=posixAccount)(objectClass=shadowAccount)).

Entry objects are mapped via the relevant table mapping rules in the nisplusLDAPattributeFromColumn and nisplusLDAPcolumnFromAttribute attributes (see below). Entry objects do not have explicit ‘nisplusLDAPobjectDN’ attributes.

If a writeObjectSpec is omitted, the effect is either to not attempt writes at all (when there is no trailing colon after the readObjectSpec), or the writeObjectSpec equals the readObjectSpec (when the readObjectSpec is followed by a colon). The ‘deleteDisp’ specifies how NIS+ object deletion should be reflected in LDAP. The following values are recognized: (1) ‘always’: Always attempt to remove the LDAP entry. (2) dbid=delDatabaseld: Set the mapped entries to values specified by the NisplusLDAPattributeFromColumn attribute values for ‘delDatabaseId’. With ‘delDatabaseId’, deletion of individual attributes can be specified by leaving the RHS of the “=” (in a mapping rule) empty. Note that the ‘delDatabaseId’ rule set should specify a ‘dn’. (3) ‘never’: Upon NIS+ object deletion, the corresponding LDAP data is left unchanged. If the NIS+ object is an entry, this means that the only effect of the deletion is to temporarily remove it from the NIS+ database cache. The ‘always’ value is the default.

The nisplusLDAPcolumnFromAttribute specifies how a NIS+ table/column value is derived from LDAP attribute values. The syntax is shown in Table 13:

TABLE 13

databaseId “:” colattrspec *(“,” colattrspec)

See below for the format of a ‘colattrspec’. As an example, mapping (by direct copy/assignment) the value of the ‘ipHostNumber’ attribute to the ‘addr’ column is accomplished using: addr=ipHostNumber.

Note that four special pseudo-columns are used to indicate non-column entry object data as shown in Table 14:

TABLE 14

| | |
|---|---|
| zo_owner | The NIS+ principal that owns the |
| | entry object. Default: inherit from |
| | table. |
| zo_group | The NIS+ group owner of the entry |
| | object. Default: inherit from table. |
| zo_access | The NIS+ access rights to the entry. |
| | Note that table column rights are |
| | stored in the table. Default: inherit |
| | from table. |
| zo_ttl | The NIS+ TTL for the entry. Note that |
| | this is NOT the TTL for the entry when |
| | cached by the compatibility program 130. |
| | Default: inherit from table. |

The nisplusLDAPattributeFromColumn attribute specifies how an LDAP attribute value is derived from NIS+ table/column values. The syntax is shown in Table 15:

TABLE 15

databaseId “:” colattrspec *(“,” colattrspec )

As a special case, if the ‘dn’ attribute value derived from a ‘colattrspec’ ends in a comma (‘,’), the ‘baseDN’ from, then the ‘writeObjectSpec’ is appended. As an example, mapping (by direct copy/assignment) the value of the ‘addr’ column to the ‘ipHostNumber’ attribute may be accomplished using ipHostNumber=addr.

The general format of a ‘colattrspec’ is shown in Table 16:

TABLE 16

| | |
|---|---|
| colattrspec | = lhs “=” rhs |
| lhs | = lval \| namespeclist |
| rhs | = rval \| [namespec] |
| namespeclist | = namespec \| “(“ namespec *(“,” namespec) ”)” |

The ‘lval’ and ‘rval’ syntax is defined below. The
format of a ‘namespec’ is:

| | |
|---|---|
| namespec | = [“ldap:”] attrspec [searchTriple] \| |
| | [“nis+:”] colspec [objectspec] |

| | |
|---|---|
| colspec | = column \| “(“ column ”)” |

| | |
|---|---|
| attrspec | = attribute \| “(“ attribute ”)” |
| searchTriple | = “:” [baseDN] [“?” [scope] [“?” [filter]]] |

| | |
|---|---|
| baseDN | = Base DN for search |

| | |
|---|---|
| scope | = “base” \| “one” \| “sub” |
| filter | = LDAP search filter |
| objectspec | = ‘objectspec’ per |
| | nisplusLDAPdatabaseIdMapping |

The repository specification in a ‘namespec’ defaults as follows: for assignments to a column, “nis+:” on the LHS, “Idap:” on the RHS. NIS+ column values on the RHS are those that exist before the NIS+ entry is modified. For assignments to an attribute, “Idap:” on the LHS, “nis+:” on the RHS. LDAP attribute values on the RHS are those that exist before the LDAP entry is modified.

Enclosing the column or attribute name in parenthesis denotes a list of column or attribute values. For attributes, the meaning is the list of all attributes of that name, and the interpretation depends on the context; see under Values and Assignments. This list specification is ignored when a ‘searchTriple’ or ‘objectspec’ is supplied.

For columns, the (colname) syntax is used to map multiple attribute instances to multiple NIS+ entries; see under Values. The ‘searchTriple’ can be used to specify an attribute from a location other than the read or write target. The defaults are as follows: (1) baseDN: If omitted, the current ‘objectDN’. If the ‘baseDN’ ends in a comma, the value of the ‘defaultSearchBase’ attribute is appended. (2) scope: “one”; (3) filter: Empty.

Similarly, the ‘objectspec’ may be used to specify a column value from a NIS+ table other than the one implicitly indicated by the databaseld. If ‘searchTriple’ or ‘objectspec’ is explicitly specified in a ‘namespec’, the retrieval/assignment, whether from/to LDAP or NIS+, is performed without checking if read/write is enabled for the LDAP container or NIS+ table.

Omitting the ‘namespec’ in an ‘rhs’ is allowed if the ‘lhs’ is one or more attributes. The effect is to delete the specified attribute(s). In all other situations, an omitted ‘namespec’ means that the rule is ignored.

The ‘filter’ can be a value (see below). For example, to find the ipHostNumber using the ‘cn’, one may specify the following in the filter field: Idap:ipHostNumber:?one?(“cn=% s”, (cname, “% s.*”)).

In order to remove ambiguity, the unmodified value of a single column or attribute can be specified as: (“% s”, namespec) when used in the filter field. If the ‘filter’ isn't specified, the ‘scope’ will be “base”, and the ‘baseDN’ is assumed to be the DN of the entry containing the attribute to be retrieved or modified.

When ‘colattrspec’s are grouped into rule sets (in the value of a nisplusLDAPcolumnFromAttribute or nisplusLDAPattributeFromColumn attribute), the evaluation of the ‘colattrspec’s proceeds in the listed order. Additional information regarding the mapping file 140 may be found, for example, in the Solaris 9 manual pages under NIS+ LDAPmapping.

The mapping file 140 supports wildcards as shown in Table 17:

TABLE 17

| | |
|---|---|
| * | Matches any number of characters |
| [x] | Matches the character ‘x’ |
| [x-y] | Matches any character in the range ‘x’ to ‘y’ (inclusive). |

Combinations such as ‘[a-cA-C0123]’ are also allowed (this
example would match any one of ‘a’, ‘b’, ‘c’, ‘A’, ‘B’,
‘C’, ‘0’, ‘1’, ‘2’, or ‘3’).

The mapping file 140 supports the string manipulations shown in Table 18:

TABLE 18

| substringextract = “(“ namespec ”,“ matchspec ”)” | |
|---|---|
| name | = column or attribute name |
| matchspec | = \“formatstring \” |

The ‘matchspec’ is a string formatted in a manner similar to the Unix function sscanf( ) format string with one format specifier, ‘% s’. The output value of the ‘substringextract’ is the substring matching the location of the ‘% s’. If there is no ‘% s’ in the ‘formatstring’, it should instead be a single character that is assumed to be a field separator for the ‘namespec’. The output values are the field values and wild cards are supported. If there is no match, the output value is the empty string, “ ”. For example, if the column ‘cname’ has the value “user.some.domain.name.”, the value of the expression: (cname, “% s.*”) is “user”, which can be used to extract the user name from a NIS+ principal name.

Similarly, the following may be used to extract the third of the colon-separated fields of the ‘shadow’ column: (shadow, “*:*:% s:*”). This form could be used to extract all of the ‘shadow’ fields. However, a simpler way to specify that special case is: (shadow, “:”).

Table 19 provides a summary of the various types of values supported in the mapping file 140:

TABLE 19

| | |
|---|---|
| lval | = “(“ formatspec “,” name spec *(“,” namespec) ”)” |
| rval | = “(“ formatspec [“,” namelist [“,” elide] ] ”)” |
| namelist | = name_or_sse *( “,” name_or_sse) |

| | |
|---|---|
| name_or_sse | = namespec \| substringextract |

| | |
|---|---|
| formatspec | = \“ formatstring \” |
| formatstring | = A string combining text and ‘%’ field specifications. |
| elide | = \“ singlechar \” |
| singlechar | = Any character |

The syntax shown in Table 19 is used to produce values (‘rval’) incorporating column or attribute values, in a manner similar to that of the Unix sprinff( ) function, or to perform assignments (‘lval’) like sscanf( ). In one embodiment, the format specifications (‘%’ plus a single character) use the designations from the LDAP function ber_printf( ). Thus, while “% s” is used to extract a string value, “% i” causes Basic Encoding Rules conversion from an integer. The following ber_printf( ) format characters are recognized: b i B n o s. If there are too few format specifiers, the format string may be repeated as needed.

When used as an ‘lval’, there is a combination of pattern matching and assignment, possibly to multiple columns or attributes. For example, in an assignment to an attribute, if the value of the ‘addr’ column is “1.2.3.4”, the ‘rval’: (“ipNetworkNumber=% s,”, addr) produces the value “ipNetworkNumber=1.2.3.4,”, while: (“(% s,% s,% s)”, host, user, domain) results in “(xyzzy,-,x.y.z)”, assuming host=“xyzzy”, user=“-”, domain=“x.y.z”.

The elide character feature may be used with attribute lists. For example: (“% s,”, (mgrprfc822mailmember), “,”) concatenates all ‘mgrprfc822mailmember’ values into one string, separated by ‘,’, and then elides the final trailing ‘,’. Thus, if mgrprfc822mailmember=usera, mgrprfc822mailmember=userb, and mgrprfc822mailmember=userc, then the value would be “usera,userb,userc”.

Note that if, for example, the NIS+ column ‘intval’ is in binary format (‘B’ column flag is set), and is to be interpreted as an integer, the following: (“% i”, intval) produces a value suitable for assignment to an integer-valued attribute.

The ‘nisPublicKey’ attribute encodes algorithm type and number (equivalent to the ‘auth_type’ column) and the public key as a single string such as “{dh192-0}xxxxxxxx” (the public key is truncated for clarity). The following will extract the corresponding ‘auth_type’ and ‘public_data’ values: (“{% s}% s”, auth_type, public_data). As a special case, combining a LHS extraction with a RHS implicit list creates multiple entries/values. For example, (“(% s,% s,% s)”, host, user, domain)=(nisNetgroupTriple) creates one NIS+ entry for each nisNetgroupTriple value.

Given the assignments shown above in Table 16, the general form of a one-to-one mapping of column to attribute assignment would be: (“% s”, colname)=(“% s”, attrname). As a convenient short-hand, this may be written as colname=attrname. List specifications (name enclosed in parenthesis) can be used to make many-to-many assignments. The expression: (colname)=(attrname) where there are multiple instances of ‘attrname’, creates one NIS+ entry for each such instance, differentiated by their ‘colname’ values. Other combinations of lists are possible, for example (attrname)=(colname), attrname=(colname), (colname)=attrname, and colname=(attrname), all of which work in the same manner as colname=attrname.

When a multi-valued RHS is assigned to a single-valued LHS, the LHS value will be the first of the RHS values. If the RHS is an attribute list, the “first” attribute is the first one returned by the LDAP server when queried. Finally, the LHS might be an explicit list of columns or attributes, such as: (name1,name2,name3).

If the RHS is single-valued, this assigns the RHS value to all entities in the list. If the RHS is multi-valued, the first value is assigned to the first entity of the list, the second value to the second entity, and so on. Excess values or entities may, for example, be silently ignored.

An exemplary mapping file 140 is provided in the computer program listing appendix submitted with this application on compact disc in the file “mapping.txt”. The mapping file provides for bi-directionally mapping between NIS+ access requests and access results and LDAP access requests and access results.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present invention may be implemented as a combination of hardware and software or in hardware alone. Note also that the implementation may vary between systems. The invention may be implemented with both object-oriented and non-object-oriented programming systems. The claims and their equivalents define the scope of the invention.

What is claimed is:

1. A method in a data processing system comprising:
receiving from a client a first access request compatible with a first naming service;
translating the first access request into a second access request compatible with a second naming service, wherein the second naming service is different than the first naming service; and
sending the second access request to a second naming service server.

2. The method of claim 1, wherein the first naming service is Network Information Services, Plus (NIS+ ).

3. The method of claim 1, wherein the second naming service is Lightweight Directory Access Protocol (LDAP).

4. The method of claim 1, wherein translating the first access request comprises:
identifying a request type; and
applying a translation rule for the request type to the first access request.

5. The method of claim 4, further comprising reading the translation rule from a mapping file.

6. The method of claim 1, wherein translating the first access response comprises:
identifying a response type; and
applying a translation rule for the response type to the first access service response.

7. The method of claim 1, further comprising selecting a translation rule comprising sub-rules, and wherein translating comprises:
evaluating the translation sub-rules using the first access request in order to generate second naming service request components.

8. The method of claim 7, wherein translating further comprises assembling the second naming service components to form at least a portion of the second access request.

9. The method of claim 1, further comprising searching a cache for a cached response to the first access request, and sending the cached response to the client.

10. A computer-readable medium containing instructions that cause a data processing system to perform a method, the method comprising:
receiving from a client a first access request compatible with a first naming service;
translating the first access request into a second access request compatible with a second naming service, wherein the second naming service is different than the first naming service;
sending the second access request to a second naming service server;
receiving a first access response compatible with the second naming service;
translating the first access response to a second access response compatible with the first naming service; and
sending the second access response to the client.

11. The computer-readable medium of claim 10, wherein the first naming service is NIS+.

12. The computer-readable medium of claim 10, wherein the second naming service is LDAP.

13. The computer-readable medium of claim 10, wherein translating the first access request comprises:
identifying a request type for the first access request; and
applying a translation rule for the request type to the access request.

14. The computer-readable medium of claim 13, further comprising reading the translation rule from a mapping file.

15. The computer-readable medium of claim 10, wherein translating the first access response comprises:
identifying a response type for the first access response; and
applying a translation rule for the response type to the first access response.

16. The computer-readable medium of claim 10, further comprising sending the second access request to a naming service server for handling the second access request.

17. The computer-readable medium of claim 10, further comprising searching a cache for a cached response to the first access request.

18. The computer-readable medium of claim 10, further comprising selecting a first translation rule comprising sub-rules, and wherein translating the first access request comprises:
evaluating the first translation sub-rules using the first access request in order to generate second naming service request components; and
assembling the second naming service components to form at least a portion of the second access request.

19. The computer-readable medium of claim 10, wherein translating the first access response comprises:
selecting a second translation rule comprising sub-rules; and
evaluating the second translation rule sub-rules using the first access response in order to generate first naming service response components, and further comprising updating a first naming service table with the first naming service response components.

20. A data processing system comprising:
a memory comprising a compatibility program, the compatibility program for receiving from a client a first access request compatible with a first naming service, translating the first access request into a second access request compatible with a second naming service, wherein the second naming service is different than the first naming service, sending the second access request to a second naming service server, receiving a first access response compatible with the second naming service, translating the first access response to a second access response compatible with the first naming service, and sending the second access response to the client; and
a processor that runs the compatibility program.

21. The data processing system of claim 20, wherein the first naming service is NIS+.

22. The data processing system of claim 20, wherein the second naming service is LDAP.

23. The data processing system of claim 20, further comprising a mapping file comprising translation rules.

24. The data processing system of claim 20, further comprising secondary storage comprising a first naming service database.

25. The data processing system of claim 23, wherein the compatibility program translates the first access request by identifying a request type for the first access request, and applying a translation rule for the request type to the access request.

26. The data processing system of claim 23, wherein the compatibility program translates the first access response by identifying a response type for the first access response, and applying a translation rule for the response type to the first access response.

27. The data processing system of claim 24, wherein the compatibility program searches the first naming service database for a cached response to the first access request.

28. The data processing sytem of claim 27, wherein the compatibility program retrieves the cached response when the cached response is within a time-to-live limit.

29. The data processing system of claim 20, further comprising a first translation rule comprising sub-rules and wherein the compatibility program translates the first access request by:
evaluating the first translation sub-rules using the first access request in order to generate second naming service request components; and
assembling the second naming service components to form at least a portion of the second access request.

30. The data processing system of claim 20, further comprising a first naming service table and a second translation rule comprising sub-rules and wherein the compatibility program translates the first access response by evaluating the second translation sub-rules using the first access response in order to generate first naming service response components, and wherein the compatibility program updates the first naming service table with the first naming service response components.

31. A data processing system comprising:
means for receiving from a client a first access request compatible with a first naming service, translating the first access request into a second access request compatible with a second naming service, receiving a first access response compatible with the second naming service, wherein the second naming service is different than the first naming service, translating the first access response to a second access response compatible with the first naming service, and sending the second access response to the client; and
means for running the compatibility program.

32. A method in a data processing system comprising:
receiving from a client an NIS+ access request at an NIS+ server;
translating the NIS+ access request into an LDAP access request according to a first mapping file entry associated with the NIS+ access request;
sending the LDAP access request to an LDAP server;
receiving an LDAP access response;
translating the LDAP access response to an NIS+ access response according to a second mapping file entry associated with the LDAP access response; and
sending the NIS+ access response to the client.

33. The method of claim 32, further comprising storing the NIS+ access response in a NIS+ database.

34. The method of claim 32, further comprising attaching a time-to-live value to the access response stored in the NIS+ database.

35. The method of claim 33, further comprising searching the NIS+ database for a cached response to the NIS+ access request.

36. The method of claim 35, further comprising sending the cached response to the client, and wherein:
translating the NIS+ access request comprises translating the NIS+ access request into an LDAP access request according to a first mapping file entry associated with the NIS+ access request, when the NIS+ database does not hold the cached response;
sending the LDAP access request comprises sending the LDAP access request to an LDAP server, when the NIS+ database does not hold the cached response;
receiving an LDAP access response comprises receiving an LDAP access response, when the NIS+ database does not hold the cached response;
translating the LDAP access response comprises translating the LDAP access response to an NIS+ access response according to a second mapping file entry associated with the LDAP access response, when the NIS+ database does not hold the cached response; and
sending the NIS+ access response comprises sending the NIS+ access response to the client, when the NIS+ database does not hold the cached response.

37. A method in a data processing system comprising:
receiving a first access response compatible with a first naming service;
translating the first access response to a second access response compatible with a second naming service, wherein the first and second naming services are different; and
sending the second access response to a second naming service client.

38. The method of claim 37, wherein translating the first access response comprises:
selecting a second translation rule comprising sub-rules; and
evaluating the second translation rule sub-rules using the first access response in order to generate first naming service response components, and further comprising updating a first naming service table with the first naming service response components.

39. The method of claim 37, wherein the data processing system comprises a second naming service table, and further comprising updating the second naming service table with the second access response.

40. The method of claim 39, further comprising storing a time-to-live value associated with the second access response in the data processing system.

41. The method of claim 37, wherein translating the first access response comprises
identifying a response type;
selecting a translation rule from a mapping file based on the response type; and
applying the translation rule to the first access response.

42. A computer-readable medium containing instructions that cause a data processing system to perform a method, the method comprising:
receiving a first access response compatible with a first naming service;
translating the first access response to a second access response compatible with the first naming service, wherein the first and second naming services are different; and
sending the second access response to a second naming service client.

43. The computer-readable medium of claim 42, wherein translating the first access response comprises:
selecting a second translation rule comprising sub-rules; and
evaluating the second translation rule sub-rules using the first access response in order to generate first naming service response components, and further comprising updating a first naming service table with the first naming service response components.

44. The computer-readable medium of claim 42, wherein the data processing system comprises a second naming service table, and further comprising updating the second naming service table with the second access response.

45. The computer-readable medium of claim 44, further comprising storing a time-to-live value associated with the second access response in the data processing system.

46. The computer-readable medium of claim 42, wherein translating the first access response comprises:
identifying a response type;
selecting a translation rule from a mapping file based on the response type; and
applying the translation rule to the first access response.
